(19) United States
(12) Patent Application Publication
(10) Pub. No.: US 2008/0112119 A1
(43) Pub. Date: May 15, 2008

(54) Flat panel display having button device integrated with front bezel

(75) Inventors: Te-Hsu Wang, Miao-Li (TW); Zhi-Yuan Cai, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/985,256

(22) Filed: Nov. 13, 2007

(30) Foreign Application Priority Data
Nov. 10, 2006 (TW) 95219920

(51) Int. Cl. G06F 1/16

(52) U.S. Cl. 361/681

(57) ABSTRACT

An exemplary flat panel display (2) includes a front bezel (21), a back cover (22), a display panel (23), and a button circuit board (28). The front bezel and the back cover cooperatively define a space for accommodating the display panel and the button circuit board. The front bezel includes a display window defined therein and a plurality of button devices (212). The button devices and the front bezel are portions of a single piece of molded material. The button devices corresponding to the button circuit board. Because the button devices of the flat panel display are inseparably integrated with the front bezel, the button devices and the front bezel can be fabricated using a single mold, and an individual mold for the button devices is not necessary. Therefore, the flat panel display has a reduced cost and a simplified fabricating process.

### FIELD OF THE INVENTION

The present invention relates flat panel displays, and particularly to a flat panel display which includes a front bezel and a plurality of button devices intergrated with the front bezel.

### GENERAL BACKGROUND

Flat panel displays are commonly used as display devices for compact electronic apparatuses. Flat panel displays typically include liquid crystal displays (LCDs), organic electroluminescent (EL) displays, plasma display panels (PDPs) and the like.

Referring to FIG. 4, a typical flat panel display 1 includes a front bezel 11, a button module 15, a display panel 13, and a back cover 12, arranged in that order from left to right as shown. The front bezel 11 and the back cover 12 cooperatively define a space (not labeled) for accommodating the display panel 13 and the button module 15.

The front bezel 11 includes an indicator lamp 117 mounted near a bottom edge thereof. The indicator lamp 117 is electrically connected to the button circuit board 18, and is configured to indicate the on-off state of the flat panel display 1. The front bezel 11 further defines a plurality of holes 112 formed in a row above the bottom edge thereof. The button module 15 includes a plurality of buttons 17 and a button circuit board 18. The buttons 17 are disposed on the button circuit board 18, and correspond to the holes 112 of the front bezel 11, respectively. The button circuit board 18 includes a plurality of fixing slots 182. The fixing slots 182 are configured to facilitate fixing of the button module 15 to the front bezel 11, with the buttons 17 protruding through the holes 112. By operating the buttons 17, a user can power on and power off the flat panel display 1, and adjust display parameters of the display panel 13.

However, because the buttons 17 are separate from the front bezel 11, an individual mold is necessary to fabricate the buttons 17 in mass production of the flat panel display 1. The mold adds to the cost of fabricating the flat panel display 1. Furthermore, in a process of assembling the flat panel display 1, the buttons 17 are first mounted to the button circuit board 18, and then the buttons 17 together with the button circuit board 18 are fixed to the front bezel 11. This process is somewhat time-consuming.

What is needed, therefore, is a new flat panel display that can overcome the above-described deficiencies.

### SUMMARY

In one preferred embodiment, a flat panel display includes a front bezel, a back cover, a display panel, and a button circuit board. The front bezel and the back cover cooperatively define a space for accommodating the display panel and the button circuit board. The front bezel includes a display window defined therein and a plurality of button devices. The button devices and the front bezel are portions of a single piece of molded material. The button devices corresponding to the button circuit board.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of a flat panel display according to an exemplary embodiment of the present invention, the flat panel display including a front bezel.

FIG. 2 is an isometric view of the front bezel of FIG. 1, but viewed from a rear aspect.

FIG. 3 is an enlarged view of a circle portion III of FIG. 2.

FIG. 4 is an exploded, isometric view of a conventional flat panel display.

### DETAILED DESCRIPTION OF PREFERRED EMBODIMENTS

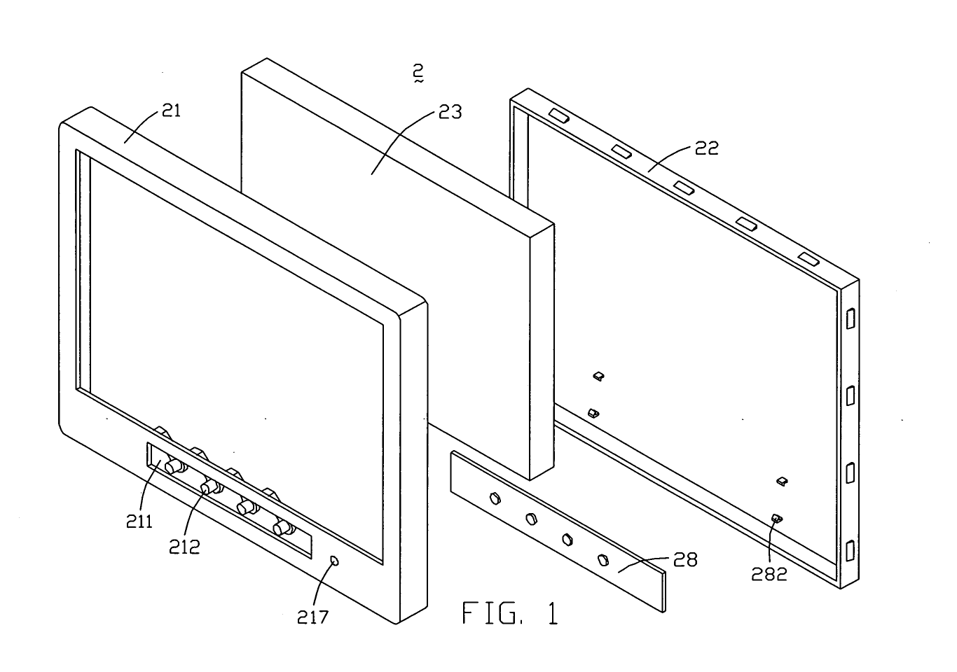

Referring to FIG. 1, a flat panel display 2 according to an exemplary embodiment of the present invention is shown. The flat panel display 2 includes a front bezel 21, a button circuit board 28, a display panel 23, and a back cover 22, arranged in that order from left to right as shown. The front bezel 21 and the back cover 22 cooperatively define a space (not labeled) for accommodating the display panel 23 and the button circuit board 28. The display panel can be a liquid crystal panel. In alternative embodiments, the display panel can be an organic electroluminescent (EL) display panel, a plasma display panel (PDP), or the like.

The front bezel 21 defines a main display window (not labeled) and a long, horizontal rectangular opening 211 below the display window. The display window is substantially rectangular, and has a size slightly less than that of the display panel 23. The display panel 23 can be viewed by a user through the display window. The front bezel 21 further includes an indicator lamp 217 and a plurality of button devices 212. The indicator lamp 217 is positioned adjacent to the opening 211, and is electrically connected to the button circuit board 28. The indicator lamp 217 is configured to indicate the on-off state of the flat panel display 2. The button devices 212 are positioned at an inner surface (not labeled) of a main body of the front bezel 21, and are inseparably integrated with the front bezel 21. That is, the front bezel 21 and the button devices 212 are portions of a single piece of material. The back cover 22 includes a pair of fixing hooks 282 formed at an inner surface (not labeled) thereof. The fixing hooks 282 are configured to fix the button circuit board 28 in a position corresponding to the button devices 212.

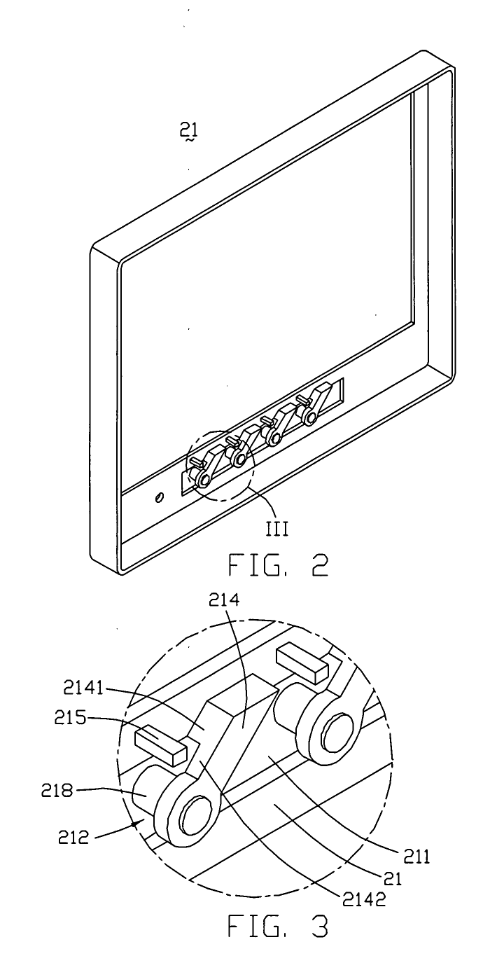

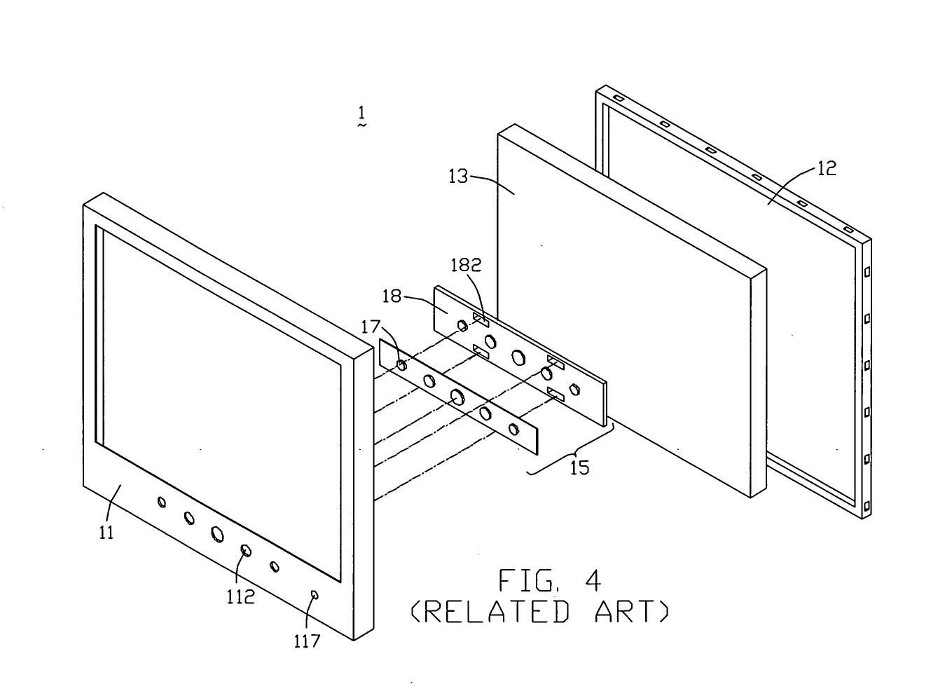

Referring also to FIG. 2 and FIG. 3, each button device 212 includes a generally L-shaped supporting arm 214 and a button 218. The supporting arm 214 includes a base portion 2141 horizontally extending from the inner surface of the front bezel 21 slightly above the opening 211, and an extending portion 2142. The extending portion 2142 perpendicularly extends from the base portion 2141. In particular, the extending portion 2142 extends down but at an oblique angle relative to the vertical, and is substantially parallel to the inner surface the front bezel 21. The button 218 perpendicularly extends from a bottom end (not labeled) of the extending portion 2142. In particular, the button 218 extends horizontally forward from the extending portion 2142. The button 218 is inseparably integrated with the supporting arm 214, which in turn is inseparably integrated with the inner surface of the front bezel 21. A horizontal gap between the extending portion 2142 and the inner surface of the front bezel 21 is equal to or greater than 3 millimeters such that the button 218 can be pressed by less labor.

The button 218 extends into the opening 211, and an end face of the button 218 is substantially coplanar with an outer surface (not labeled) of the front bezel 21. Thereby, the button 218 can be easily operated by a user. By operating various of the buttons 218, the user can power on and power off the flat panel display 2 or adjust display parameters of the display panel 23. The front bezel 21 further includes a plurality of reinforcing blocks 215 rearwardly extending from the inner surface of the front bezel 21. The reinforcing blocks 215 are positioned slightly above the opening 211, and are arranged alternately between the base portions 2141 of the button devices 212. When one of the buttons 218 is pressed, the corresponding adjacent reinforcing blocks 215 abut against the button circuit board 218 so as to prevent the front bezel 21 from being distorted. This also helps prevent unwanted movements of the button devices 212.

Unlike with a conventional flat panel display, the button devices 212 of the flat panel display 2 are inseparably integrated with the front bezel 21. Thus, the button devices 212 and the front bezel 21 can be fabricated using a single mold, and an individual mold for the button devices 212 is not necessary. Therefore, the flat panel display 2 has a reduced cost and a simplified fabricating process.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A flat panel display comprising:
a display panel;
a button circuit board;
a back cover; and
a front bezel comprising a display window defined therein and a plurality of button devices, the button devices and the front bezel being portions of a single piece of molded material, the front bezel and the back cover cooperatively defining a space for accommodating the display panel and the button circuit board, and the button devices corresponding to the button circuit board.

2. The flat panel display as claimed in claim 1, wherein the display window corresponds to the display panel, and a size of the display window is less than a size of the display panel.

3. The flat panel display as claimed in claim 1, wherein the front bezel further comprises an opening adjacent to the display window, and the button devices are at least partly received in the opening.

4. The flat panel display as claimed in claim 3, wherein each of the button devices comprises a supporting arm, and the supporting arm comprises a base portion horizontally extending from a position of an inner surface of the front bezel above the opening and an extending portion extending from the base portion.

5. The flat panel display as claimed in claim 4, wherein the extending portion is substantially parallel to the inner surface of the front bezel.

6. The flat panel display as claimed in claim 5, wherein the extending portion extends down from the base portion at an oblique angle relative to the vertical.

7. The flat panel display as claimed in claim 5, wherein a horizontal gap between the extending portion and the inner surface of the front bezel is equal to or greater than 3 millimeters.

8. The flat panel display as claimed in claim 4, wherein the button device further comprises a button extending from an end of the extending portion.

9. The flat panel display as claimed in claim 8, wherein the button extends into the opening, and an end face of the button is substantially coplanar with an outer surface of the front bezel.

10. The flat panel display as claimed in claim 1, wherein the front bezel further comprises an indicator lamp, the indicator lamp being configured for indicating an on-off state of the flat panel display.

11. The flat panel display as claimed in claim 1, wherein the front bezel further comprises a plurality of reinforcing members, the reinforcing members being arranged alternately between the button devices.

12. The flat panel display as claimed in claim 1, wherein the display panel is a liquid crystal panel.

13. The flat panel display as claimed in claim 1, wherein the display panel is an organic electroluminescent display panel.

14. The flat panel display as claimed in claim 1, wherein the display panel is a plasma display panel.

15. The flat panel display as claimed in claim 1, wherein the back cover comprises at least one fixing detent fixing the button circuit board in position relative to the button devices.

16. A flat panel display comprising:
a display panel; and
a chassis accommodating the display panel, the chassis comprising a front bezel and a back cover, the front bezel comprising at least one button device inseparably integrated therewith, the at least one button device provided for executing at least one of powering on and powering off the flat panel display, and adjusting at least one display parameter of the display panel.

17. The flat panel display as claimed in claim 16, further comprising a button circuit board, wherein the at least one button device corresponds to the button circuit board.

18. The flat panel display as claimed in claim 17, wherein the front bezel further comprising a display window corresponding to the display panel, a size of the display window being less than a size of the display panel.

19. The flat panel display as claimed in claim 18, wherein the front bezel further comprises an opening adjacent to the display window, wherein the button devices are at least partly received in the opening.
